(19) United States
(12) Patent Application Publication
(10) Pub. No.: US 2010/0205067 A1
(43) Pub. Date: Aug. 12, 2010

(54) Method of conducting a maximum buyout price amount auction

(76) Inventor: Jonathan M. Gottehrer, Massapequa, NY (US)

Correspondence Address: RICHARD L. MILLER, 12 PARKSIDE DRIVE, DIX HILLS, NY, 11746, US

(21) Appl. No.: 12/798,770

(22) Filed: Apr. 9, 2010

Related U.S. Application Data
(63) Continuation-in-part of application No. 11/481,300, filed on Jul. 5, 2006, now abandoned.

(51) Int. Cl. G06Q 30/00; G06Q 20/00

(52) U.S. Cl. 705/26

(57) ABSTRACT

A method of conducting a maximum buyout price amount auction that comprises the steps of: 1. placing an item for auction on an auction site by a seller; 2. stating a maximum buyout price amount for the item on the auction site by the seller; 3. indicating a start time for the auction on the auction site; 4. listing all bids received from bidders for the item on the auction site; 5. accepting the highest bid from the highest bidder on the auction site by the seller, even though the highest bid may not be the maximum buyout price amount; 6. stopping the auction on the auction site; 7. informing the highest bidder that the bidder has won the auction on the auction site; 8. making payment to the seller of the item by the highest bidder; and 9. sending the item to the highest bidder by the seller.

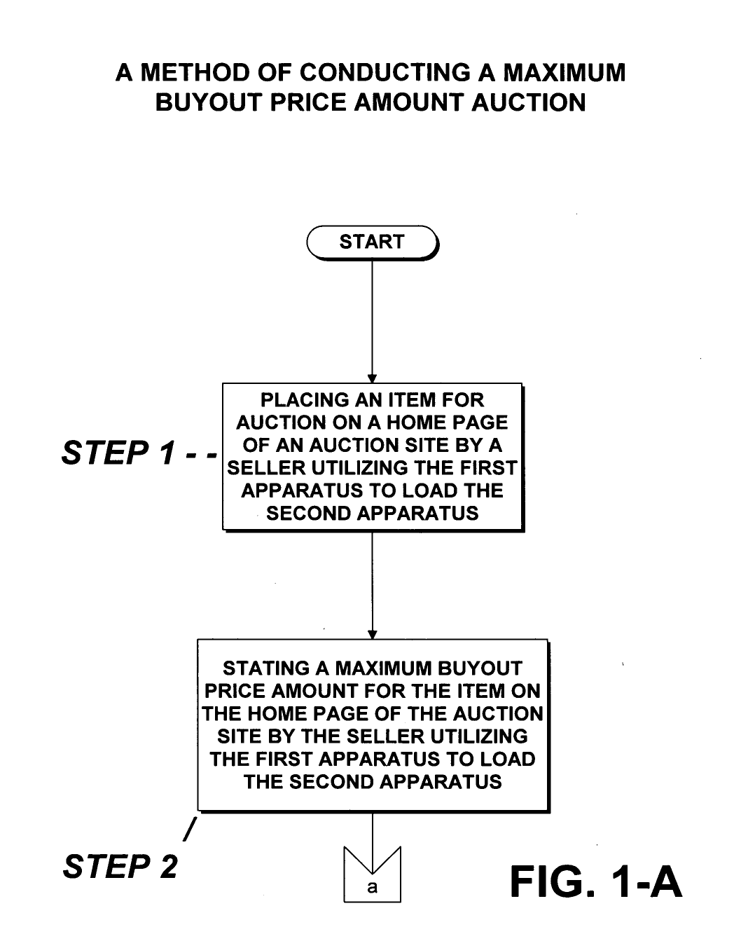

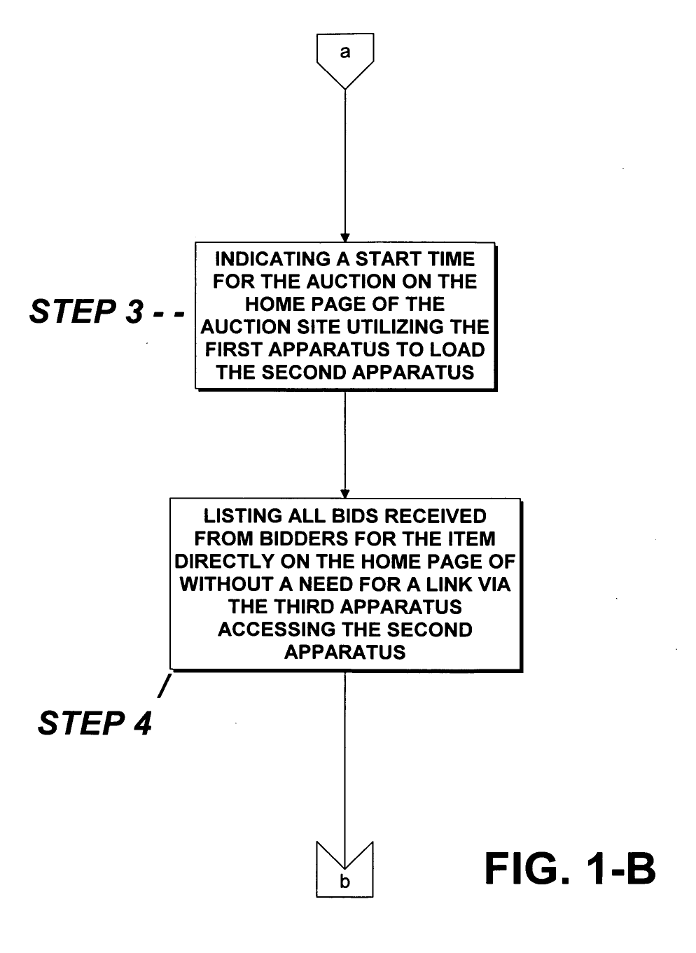

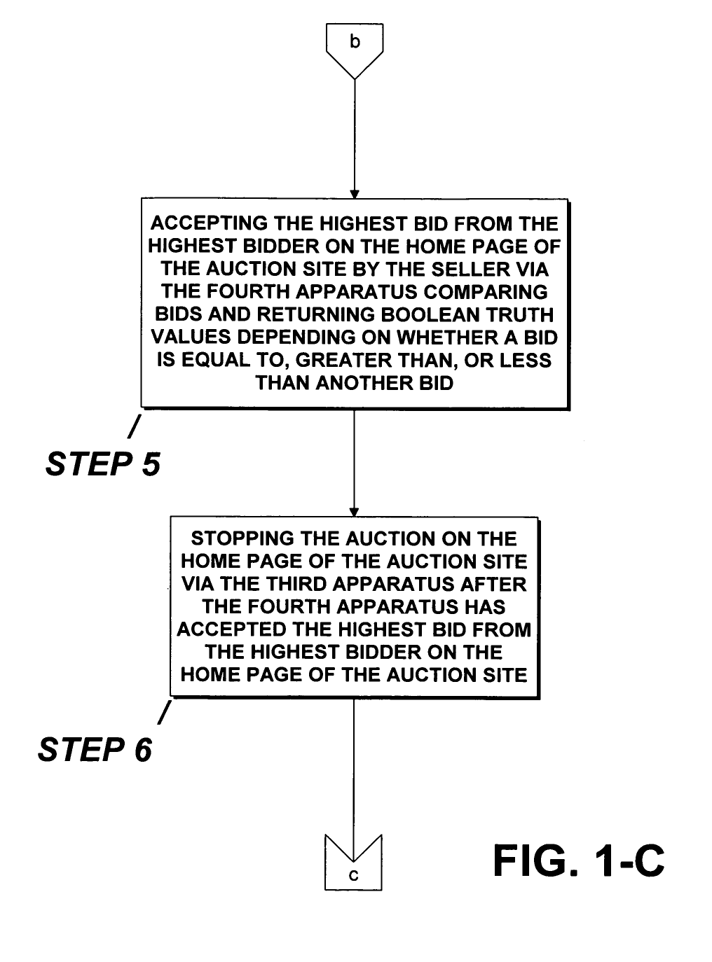

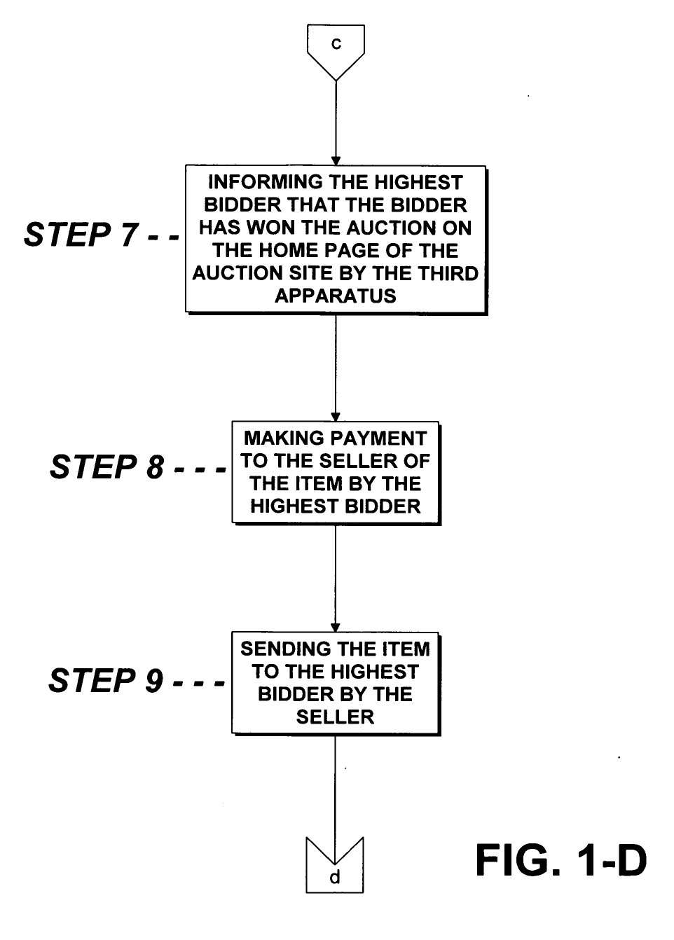

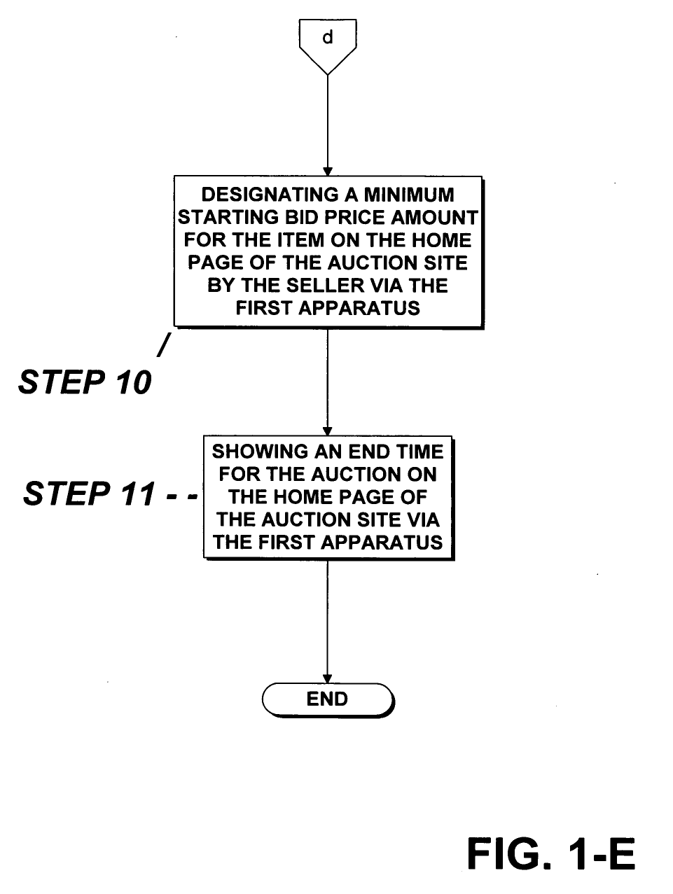

### BACKGROUND OF THE INVENTION

1. Field of the Invention

The present invention relates to an auction which is particularly suitable to an online auction but which does not necessarily have to be online and could be conducted by other methods, and more particularly, a method of conducting a maximum buyout price amount auction.

2. Technical Information

From a listing in an auction glossary by DoveBid: “Buyout Price. A price designated by the Seller that, if paid, will sell the item immediately and close the auction. A Buyout Price is an optional feature when listing an asset, and if there is no mention of it on an item's Asset Detail page, the seller has not used this feature. Buyouts create an opportunity for buyers disinclined to wait until the end of an auction to buy. Buyouts also enable Sellers to create fixed price sales, just like a traditional ecommerce store. Just make the Opening and Buyout prices the same, and the first bid will be the winning bid.”

An abstract from a article titled, “A Risk Averse Seller in a Continuous Time Auction with a Buyout Option” by Timothy Mathews: “An auction with a buyout option occurring over continuous time with rules similar to eBay's ‘buy it now’ option is analyzed. It is shown that a risk averse seller facing risk neutral bidders will choose a buyout price low enough so that the buyout option is exercised with positive probability in equilibrium. Further, when the seller is risk averse and bidders are risk neutral, allowing the seller to offer a buyout option results in an ex ante Pareto improvement, compared to a similar auction without such an option.”

An abstract from another article titled, “The role of varying risk attitudes in an auction with a buyout option” by Timothy Mathews and Brett Katzman: “An auction with a buyout option is modelled. Such an option allows a bidder to purchase the item being auctioned at a pre-specified buyout price, instead of attempting to obtain the item through the traditional auction procedure. This analysis is motivated by internet auctions where such options are present. If all auction participants are risk neutral, the seller will choose a buyout price high enough so that the option is never exercised. However, a risk averse seller facing risk neutral bidders will choose a price low enough so that the option is exercised with positive probability. Further, if bidders are risk neutral and the seller is risk averse, this option may result in a Pareto improvement compared to a sealed bid second price auction”.

### DESCRIPTION OF THE PRIOR ART

Numerous innovations for auctions have been provided in the prior art that will be described. Even though these innovations may be suitable for the specific individual purposes to which they address, however, they differ from the present invention.

A FIRST EXAMPLE, U.S. Patent Office Document No. 2001/0032164 A1, Published on Oct. 18, 2001, to Kim teaches a method and apparatus for bi-directionally auctioning using a computer network, wherein one or more purchase prices and an accumulated purchase quantity of goods at or above each purchase price are displayed in real time. A plurality of buyers participate competitively by registering a purchase price. A higher-price-accumulated purchase quantity is then determined by summing the quantity of similar goods at or above each registered purchase price. Sellers select an acceptable purchase price competitively by referring to each displayed purchase price and higher-price-accumulated purchase quantity. A transaction between a seller selecting first and all buyers who register goods at or above the selected purchase price is consummated. A similar bi-auction system for sellers making bids and a buyer purchasing a higher-price-accumulated quantity of goods is provided by implementing the present invention mutatis mutandis with sellers as buyers and vice-versa. In that case, the higher-price-accumulated amount is at or below each registered sale price.

A SECOND EXAMPLE, U.S. Patent Office Document No. 2004/0215527 A1, Published on Oct. 28, 2004, to Grove et al. teaches an auction method that presents an auction price-setting process and a fixed price process for purchasing a seller's offering to a buyer. The seller is provided with a mechanism to adjust and publish a seller fixed-price offer during the auction price-setting process.

A THIRD EXAMPLE, U.S. Patent Office Document No. 2004/0267624 A1, Published on Dec. 30, 2004, to Nuriel teaches an auction method which allows an individual the opportunity to purchase an item through bidding on an auction of the item at a fixed limit price or lower. A set number of bidders each pay a nominal fee to bid on the item and bid at any price lower than the set limit price. If more than one person bids the same amount on that item, his/her bids are eliminated. This process continues until the set number of people bid. The person with the highest unmatched bid will have the opportunity to buy that item for the price that he/she bid. The auction can also be timed out after a certain number of days.

A FOURTH EXAMPLE, U.S. Patent Office Document No. 2005/0027641 A1, Published on Feb. 3, 2005, to Grove et al. teaches an auction price-setting method to present an auction price-setting process and a fixed price process to provide a fixed price offer for an item and to publish the fixed price offer on a listing based on a criteria.

A FIFTH EXAMPLE, U.S. Patent Office Document No. 2005/0289043 A1, Published on Dec. 29, 2005, to Maudlin teaches a one-sided seller-defined method and system for maximizing a seller's profit by withholding supply in Vickery auctions based on a market-derived reserve price calculated from the buyers' bids in order to maximize revenues and/or profits to the seller(s).

A SIXTH EXAMPLE, U.S. Patent Office Document No. 2006/0080213 A1, Published on Apr. 13, 2006, to Inoue teaches an auction system that has a marketable auction device 2 to actuate a purchasing scale distinction member provided to distinguish large lot buyers who bid more than 2 unit number from small lot buyers who bid falling short of 2 unit number. A redistribution member works to multiply a factor 1.2 by counterbidding prices that the large lot buyers tender so as to produce estimation prices, while at the same time, producing estimation prices equal to counterbidding prices which the small lot buyers bid without multiplication. Then, the redistribution member determines successful bidders preferentially in order from those who have highest counterbidding prices against the gross unit quantity of the perishable products so that a lowest successful bid price among the successful bidders is determined to be a contract price for all the successful bidders. The auction system enables an auction market to keep higher contract prices through the bidding season so as to enhance the gross net sale without an erratic fluctuation.

A SEVENTH EXAMPLE, U.S. Patent Office Document No. 2006/0095365 A1, Published on May 4, 2006, to Ravikumar et al. teaches a system and method are disclosed for conducting an auction in a peer-to-peer network. In one example, the method includes initiating the auction by notifying a p-commerce server of the auction's start time, end time, and item being auctioned. A bid is received for the auction directly from another endpoints, and all endpoint that have previously submitted a bid in the auction are directly notified of the received bid. The p-commerce server is instructed to stop the auction after a determination is made that the auction has ended. A highest bid from the submitted bids is identified and the endpoint that submitted the highest bid is directly notified that it has won the auction.

It is apparent now that numerous innovations for auctions have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a method of conducting a maximum buyout price amount auction that avoids the disadvantages of the prior art.

ANOTHER OBJECT of the present invention is to provide a method of conducting a maximum buyout price amount auction that is simple and inexpensive to construct.

STILL ANOTHER OBJECT of the present invention is to provide a method of conducting a maximum buyout price amount auction that is simple to use.

BRIEFLY STATED, STILL YET ANOTHER OBJECT of the present invention is to provide a method of conducting a maximum buyout price amount auction that comprises the steps of: 1. placing an item for auction on an online auction site by a seller; 2. stating a maximum buyout price amount for the item on the online auction site by the seller; 3. indicating a start time for the auction on the online auction site; 4. listing all bids received from bidders for the item on the online auction site; 5. accepting the highest bid from the highest bidder on the online auction site by the seller, even though the highest bid may not be the maximum buyout price amount; 6. stopping the auction on the online auction site; 7. informing the highest bidder that the bidder has won the auction on the online auction site; 8. making payment to the seller of the item by the highest bidder; and 9. sending the item to the highest bidder by the seller.

The novel features which are considered characteristic of the present invention are set forth in the appended claims. The invention itself, however, both as to its construction and its method of operation, together with additional objects and advantages thereof, will be best understood from the following description of the specific embodiments when read and understood.

### DETAILED DESCRIPTION OF THE PREFERRED EMBODIMENT

Referring now to the present invention which is, a method of conducting a maximum buyout price amount auction that comprises the steps of: 1. placing an item for auction on an online auction site by a seller; 2. stating a maximum buyout price amount for the item on the online auction site by the seller; 3. indicating a start time for the auction on the online auction site; 4. listing all bids received from bidders for the item on the online auction site; 5. accepting the highest bid from the highest bidder on the online auction site by the seller, even though the highest bid may not be the maximum buyout price amount; 6. stopping the auction on the online auction site; 7. informing the highest bidder that the bidder has won the auction on the online auction site; 8. making payment to the seller of the item by the highest bidder; and 9. sending the item to the highest bidder by the seller.

The method can further comprise the step of designating a minimum starting bid price amount for the item on the online auction site by the seller. The method can also further comprise the step of showing an end time for the auction on the online auction site.

The maximum buyout price amount auction is a time expiring auction where the seller contractually must supply a maximum buyout price amount to all bidders on the online auction site, which if paid supersedes all lower bids and terminates the auction. If the maximum buyout price amount is not reached then the highest bidder wins. The seller MUST ACCEPT the highest bid. Upon default by the seller/winning bidder or in the case of any interruptions the online auction site has authority/discretion as to further proceedings for the auction.

In contradistinction in a conventional buyout auction the seller has the option not to accept the highest bid below the buyout price.

It is to be distinctly understood that although the terminology online auction is used often in this disclosure the auction methods herein describe can be conducted in other manners and does not have to be an online auction.

While it may appear that the maximum buyout auction appears to greatly benefit the buyer it should be noted that the motives of the seller might not be monetary. Perhaps the seller really just wants to get rid of the items to be auctioned at almost any cost.

It will be understood that each of the elements described above, or two or more together, may also find a useful application in other types of constructions differing from the types described above.

While the invention has been illustrated and described as embodiments of a method of conducting a maximum buyout price amount auction, accordingly it is not limited to the details indicated, since it will be understood that various omissions, modifications, substitutions and changes in the forms and details of its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

1. (canceled)

2. (canceled)

3. (canceled)

4. (canceled)

5. A method of conducting a maximum buyout price amount auction, which is tied to a machine that manipulates data according to a set of instructions, wherein the machine includes a first apparatus, a second apparatus, a third apparatus, and a fourth apparatus, wherein the first apparatus provides communication between the machine and an environment outside of the machine, wherein said second apparatus can be read and written to for storing information, wherein said third apparatus manages the machine by reading and interpreting the set of instructions transforming them into a series of control signals that activate other parts of the machine, and wherein the fourth apparatus performs arithmetic and logical operations, the method comprising the steps of:
a) placing an item for auction on a home page of an auction site by a seller utilizing the first apparatus to load the second apparatus;
b) stating a maximum buyout price amount for the item on the home page of the auction site by the seller utilizing the first apparatus to load the second apparatus;
c) indicating a start time for the auction on the home page of the auction site utilizing the first apparatus to load the second apparatus;
d) listing all bids received from bidders for the item directly on the home page of without a need for a link via the third apparatus accessing the second apparatus;
e) accepting the highest bid from the highest bidder on the home page of the auction site by the seller via the fourth apparatus comparing bids and returning boolean truth values depending on whether a bid is equal to, greater than, or less than another bid;
f) stopping the auction on the home page of the auction site via the third apparatus after the fourth apparatus has accepted the highest bid from the highest bidder on the home page of the auction site;
g) informing the highest bidder that the bidder has won the auction on the home page of the auction site by the third apparatus;
h) making payment to the seller of the item by the highest bidder; and
i) sending the item to the highest bidder by the seller.

6. The method of claim 5, further comprising the step of designating a minimum starting bid price amount for the item on the home page of the auction site by the seller via the first apparatus.

7. The method of claim 5, further comprising the step of showing an end time for the auction on the home page of the auction site via the first apparatus.

8. A method of conducting a maximum buyout price amount auction, which is tied to a machine that manipulates data according to a set of instructions, wherein the machine includes a first apparatus, a second apparatus, a third apparatus, and a fourth apparatus, wherein the first apparatus provides communication between the machine and an environment outside of the machine, wherein said second apparatus can be read and written to for storing information, wherein said third apparatus manages the machine by reading and interpreting the set of instructions transforming them into a series of control signals that activate other parts of the machine, and wherein the fourth apparatus performs arithmetic and logical operations, the method comprising the steps of:
a) placing an item for auction on a home page of an auction site by a seller utilizing the first apparatus to load the second apparatus;
b) stating a maximum buyout price amount for the item on the home page of the auction site by the seller utilizing the first apparatus to load the second apparatus;
c) indicating a start time for the auction on the home page of the auction site utilizing the first apparatus to load the second apparatus;
d) listing all bids received from bidders for the item directly on the home page of the auction site without a need for a link via the third apparatus accessing the second apparatus;
e) accepting the highest bid from the highest bidder on the home page of the auction site by the seller via the fourth apparatus comparing bids and returning boolean truth values depending on whether a bid is equal to, greater than, or less than another bid;
f) stopping the auction on the home page of the auction site via the third apparatus after the fourth apparatus has accepted the highest bid from the highest bidder on the home page of the auction site;
g) informing the highest bidder that the bidder has won the auction on the home page of the auction site by the third apparatus;
h) making payment to the seller of the item by the highest bidder;
i) sending the item to the highest bidder by the seller;
j) designating a minimum starting bid price amount for the item on the home page of the auction site by the seller via the first apparatus; and
k) showing an end time for the auction on the home page of the auction site via the first apparatus.
